(19) United States
(12) Patent Application Publication
(10) Pub. No.: US 2021/0061832 A1
(43) Pub. Date: Mar. 4, 2021

(54) Phenoxyimine-Based Complexes and Related Ring-Opening Metathesis Polymerization Methods

(71) Applicant: ExxonMobil Chemical Patents Inc., Baytown, TX (US)

(72) Inventors: Gursu Culcu, Humble, TX (US); Catherine A. Faler, Houston, TX (US); David A. Cano, Houston, TX (US)

(21) Appl. No.: 16/989,070

(22) Filed: Aug. 10, 2020

Related U.S. Application Data
(60) Provisional application No. 62/895,600, filed on Sep. 4, 2019.

(51) Int. Cl. C07F 11/00; C08F 4/78; B01J 31/22

(52) U.S. Cl. CPC C07F 11/005; C08F 4/78; B01J 2531/66; B01J 2231/543; B01J 2531/64; B01J 31/2295

(57) ABSTRACT

Phenoxyimine-based complexes, when activated, are suitable for catalyzing ring-opening metathesis polymerization (ROMP) reactions of cyclopentene and a comonomer under mild reaction conditions, for example, at reaction temperatures of about −196° C. and about 70° C. in diluents like toluene. The use of such activated phenoxyimine-based complexes may favor polymer products with a high cis-content.

### CROSS-REFERENCE OF RELATED APPLICATIONS

This application claims the benefit of U.S. Provisional Application No. 62/895,600, filed Sep. 4, 2019, the disclosure of which is incorporated herein by reference.

### FIELD

The present disclosure relates to catalysts for ring-opening metathesis polymerization (ROMP) reactions.

### BACKGROUND

In organic synthesis, a metathesis reaction is a catalytic reaction in which recombination of the double bonds occurs between two kinds of olefins or alkynes. ROMP involves the formation of polyolefins from the ring opening of monomers. Generally, the cyclic olefin monomers are strained cyclic olefins that react with a ROMP catalyst to open and relieve the strain, which produces vinyl groups that react with other opened olefins.

There are very few known ROMP catalysts. ROMP catalysts are transition metal carbene complexes, also referred to as Grubbs catalysts. The synthesis of such metal-oxo complexes is achieved by refluxing a toluene solution of the protonated ligand with MOCl₄ (M═W or Mo), which produces HCl as a byproduct. Then, the metal-oxo complexes are reflexed with the preferred isocyanate to produce the metal-imido complex, which produces CO₂ as a byproduct. The targeted metal complexes may then be purified by column chromatography or other laborious step. The synthesis conditions of ROMP catalysts are harsh, and the synthesis and purification are time consuming Additional ROMP catalysts, especially those that can be synthesized quickly and under mild conditions, are needed.

One reference of interest includes: “Imidotungsten (VI) complexes with chelating phenols as ROMP catalysts,” by Juuso Hakala et al., in 14(9) INORG. CHEM. Comm. 1362-1364 (2011).

### SUMMARY OF THE INVENTION

The present disclosure relates to catalysts for ROMP reactions.

The present disclosure includes a compound represented by Formula (1) where M is tungsten or molybdenum, R₁ and R₂ are independently H or C₁-C₂₀ hydrocarbyl, each X is independently a halide or’ with the proviso that at least two of the X moieties are halides, R′ is H or C₁-C₂₀ hydrocarbyl, E is oxygen (O), sulfur (S), selenium (Se), tellurium (Te), or an amide with the formula —NR, where R is H or C₁-C₂₀ hydrocarbyl; and Ar₁ and Ar₂ are independently substituted or unsubstituted C₆-C₄₀ aryl groups that optionally include one or more heteroatoms.

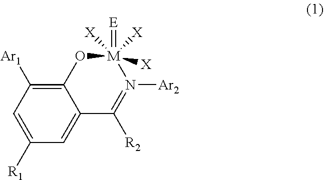

The present disclosure also includes a compound represented by Formula (la) where each of R₃ and R₄ are independently H or a C₁-C₂₀ hydrocarbyl

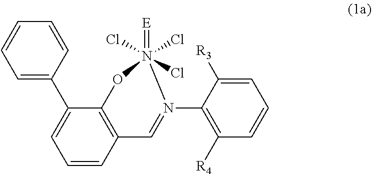

The present disclosure also includes a method of synthesizing a compound of Formula (1) comprising contacting a compound represented by Formula (L) with a compound represented by the formula M(O)X₄ in a diluent in the presence of a base, where M is tungsten or molybdenum, R₁ and R₂ are independently H or C₁-C₂₀ hydrocarbyl, each X is independently a halide or′ with the proviso that at least three of the X moieties are halides, R′ is H or C₁-C₂₀ hydrocarbyl, E is oxygen (O), sulfur (S), selenium (Se), tellurium (Te), or an amide with the formula −NR″, where R″ is H or C₁-C₂₀ hydrocarbyl; and Ar₁ and Ar₂ are independently substituted or unsubstituted C₆-C₄₀ aryl groups that optionally include one or more heteroatoms.

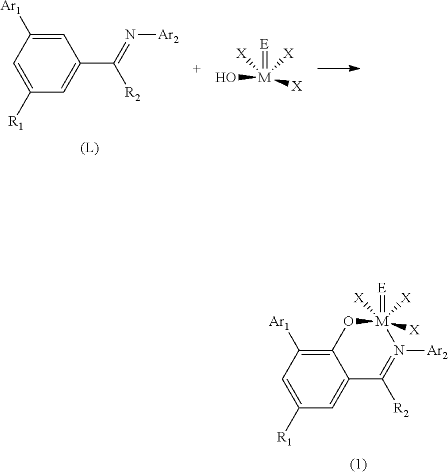

The present disclosure also includes a method of polymerizing an cyclic olefin monomer comprising contacting a precatalyst of Formula (1) with an activator in the presence of the cyclic olefin monomer, wherein M is tungsten or molybdenum, R₁ and R₂ are independently H or C₁-C₂₀ hydrocarbyl, each X is independently a halide or′ with the proviso that at least three of the X moieties are halides, E is oxygen (O), sulfur (S), selenium (Se), tellurium (Te), or an amide with the formula —NR″, where R″ is H or C₁-C₂₀ hydrocarbyl; and Ar₁ and Ar₂ are independently substituted or unsubstituted C₆-C₄₀ aryl groups that optionally include one or more heteroatoms.

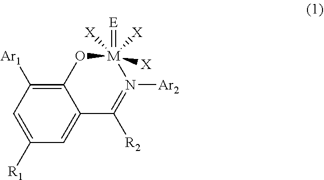

### DETAILED DESCRIPTION

The present disclosure relates to phenoxyimine-based complexes that, when activated, are suitable for catalyzing ROMP reactions. Advantageously, the phenoxyimine-based complexes described herein are synthesized in a 1-step process under mild conditions that do not produce hazardous bright products like HCl and CO₂. Further, the ROMP reactions catalyzed with activated phenoxyimine-based complexes produce polymers with a high cis-content.

### Definitions

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table, inclusive of the lanthanides and actinide elements. Ti, Zr, and Hf are Group 4 transition metals, for example.

The terms “hydrocarbyl radical,” “hydrocarbyl group,” or “hydrocarbyl” may be used interchangeably and are defined to mean a group consisting of hydrogen and carbon atoms only and bearing at least one unfilled valence position when removed from a parent compound. Preferred hydrocarbyls are C₁-C₁₀₀ radicals that may be linear or branched. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like. The term “hydrocarbyl group having 1 to about 100 carbon atoms” refers to a moiety selected from a linear or branched C₁-C₁₀₀ alkyl.

The term “optionally substituted” means that a hydrocarbon or hydrocarbyl group may be unsubstituted or substituted. For example, the term “optionally substituted hydrocarbyl” refers to replacement of at least one hydrogen atom or carbon atom in a hydrocarbyl group with a heteroatom or heteroatom functional group. Unless otherwise specified, any of the hydrocarbyl groups herein may be optionally substituted. The term “optionally substituted” means that a group may be unsubstituted or substituted. For example, the term “optionally substituted hydrocarbyl” refers to replacement of at least one hydrogen atom or carbon atom in a hydrocarbyl group with a heteroatom or heteroatom-containing group. Unless otherwise specified, any of the hydrocarbyl groups herein may be optionally substituted.

The terms “linear” or “linear hydrocarbon” refer to a hydrocarbon or hydrocarbyl group having a continuous carbon chain without side chain branching.

The terms “branched” or “branched hydrocarbon” refer to a hydrocarbon or hydrocarbyl group having a linear carbon chain or a closed carbon ring, in which a hydrocarbyl side chain extends from the linear carbon chain or the closed carbon ring.

For purposes of this disclosure, when a polymer, copolymer, or oligomer is referred to as comprising an olefin, the olefin present in such polymer, copolymer or oligomer is the polymerized form of the olefin monomer. For example, when a copolymer is said to have an “propylene” content of 0 wt % to 5 wt %, it is to be understood that the mer unit in the copolymer is derived from the monomer propylene in the polymerization reaction and said derived units are present at 0 wt % (i.e., absent) to 5 wt %, based upon the weight of the copolymer. As used herein, “polymer” and “oligomer” (and grammatical variations thereof) are used interchangeably to refer to a molecule having two or more of the same or different mer units. As used herein, “polymerize” (and grammatical variations thereof, e.g., polymerization) are used interchangeably to refer to a process of generating a molecule having two or more of the same or different mer units from two or more of the same or different monomers. A “homopolymer” is a polymer (or oligomer) having mer units that are the same. A “copolymer” is a polymer (or oligomer) having two or more mer units that are different from each other. “Different,” as used to refer to mer units, indicates that the mer units differ from each other by at least one atom or are different isomerically.

The term “independently,” when referenced to selection of multiple items from within a given group, means that the selected choice for a first item does not necessarily influence the choice of any second or subsequent item. That is, independent selection of multiple items within a given group means that the individual items may be the same or different from one another.

The terms “alkene” and “olefin” are used synonymously herein. Similarly, the terms “alkenic” and “olefinic” are used synonymously herein. Unless otherwise noted, all possible geometric isomers are encompassed by these terms.

The following abbreviations may be used through this specification: Ph is phenyl.

### Phenoxyimine-Based Complexes and Catalyst Systems Derived Therefrom

Phenoxyimine-based complexes are useful as precatalysts that, when activated, are suitable for catalyzing ROMP reactions. The term “catalyst system” refers to the combination of (a) a precatalyst and at least one activator or (b) an activated reaction product of (a).

Examples of precatalysts suitable for use in the methods and catalyst systems described herein include those characterized by Formula (1) below.

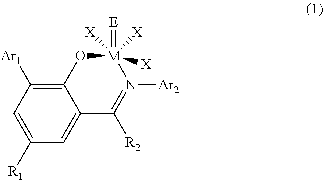

In Formula (1), M is tungsten or molybdenum; R₁ and R₂ are independently H or C₁-C₂₀ hydrocarbyl; each X is independently a halide or′ with the proviso that at least two of the X moieties are halides, where R′ is H or C₁-C₂₀ hydrocarbyl; E is oxygen (O), sulfur (S), selenium (Se), tellurium (Te), or an amide with the formula —NR″, where R″ is H or C₁-C₂₀ hydrocarbyl (preferably E is O or —NR″); and Ar₁ and Ar₂ are independently substituted or unsubstituted C₆-C₄₀ (preferably C₆-C₂₀) aryl groups that optionally include one or more heteroatoms.

For example, Ar₁ may be a phenyl group, each of R₁ and R₂ may be hydrogen, and Ar₂ may be an optionally di-substituted phenyl group as shown in Formula (1a) below.

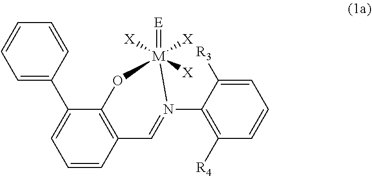

In Formula (1a), each of R₃ and R₄ may independently be H or a C₁-C₂₀ hydrocarbyl group.

Preferred examples of Formula (1a) include those, depicted below as Formulas (1a-1) and (1a-2). Specifically, for Formula (1a-1), each of the R₃ and R₄ groups in Formula (1a) are methyl, each X is Cl, M is W, and E is O. For formula (1a-2), the R₃ group in Formula (1a) is an isopropyl group, the R₄ group is H, each X is Cl, M is W, and E is O.

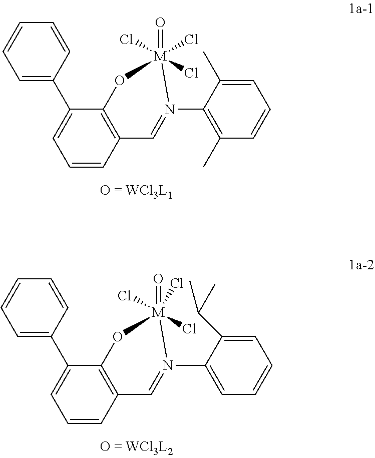

Phenoxyimine-based complexes described herein may be synthesized by contacting a ligand with a compound represented by the empirical formula MOX₄ in the presence of a base in a solvent. In the formula MOX₄, M is a group 5 metal, and X is a halide (i.e., fluoro, chloro, bromo, or iodo groups) or an oxy (—OR′) group, provided that at least three of the four X moieties are halides. In the oxy group, R′ may be H or C₁-C₂₀ hydrocarbyl.

Suitable ligands for use in the methods and compositions described herein may be characterized by Formula (L) below.

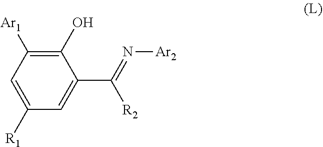

In Formula (L), R₁ and R₂ are independently H or C₁-C₂₀ hydrocarbyl; and Ar₁ and Ar₂ are independently substituted or unsubstituted C₆-C₄₀ aryl groups that optionally include one or more heteroatoms.

Synthesizing the precatalyst (contacting the ligands and MOX₄) may be in the presence of a base, for example, an organo-lithium reagent or an organo-sodium reagent. Examples of bases include, but are not limited to, methyllithium, n-propyllithium, isopropyllithium, n-butyllithium, tertiary butyllithium, phenyllithium, alkali metal hydrides, alkali metal bis(trimethylsilyl)amide complexes, tertiary amines (e.g., trimethylamine), and the like, and any combination thereof. n-butyllithium is a preferred base.

Synthesizing the precatalyst may be at a temperature of between about −196° C. and about 70° C., or about −196° C. to about 25° C., or about −110° C. to about 0° C., or about 0° C. to about 70° C., or about 0° C. to about 25° C.

Synthesizing the precatalyst may be in a diluent. Examples of suitable diluents include, but are not limited to, pentane, hexane, heptane, cyclohexane, benzene, toluene, xylene, ethyl benzene, and the like, and any combination thereof. Toluene is a preferred diluent.

In a nonlimiting example of Formula (L), Ar₁ may be a phenyl group, each of R₁ and R₂ may be hydrogen, and Ar₂ may be an optionally di-substituted phenyl group as shown in Formula (L′) below.

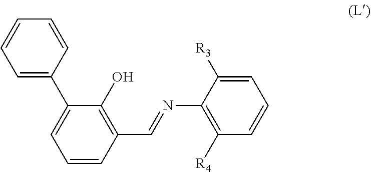

In Formula (L′), each of R₃ and R₄ may independently be H or a C₁-C₂₀ hydrocarbyl group.

In a first nonlimiting example, the ligand may be 3-(((2,6-dimethylphenyl)imino)methyl)-[1,1′-biphenyl]-2-ol, referred to herein as L₁, which is L′ wherein each of the R₃ and R₄ groups are methyl). A compound of Formula (1a-1) may be prepared by the reaction depicted below.

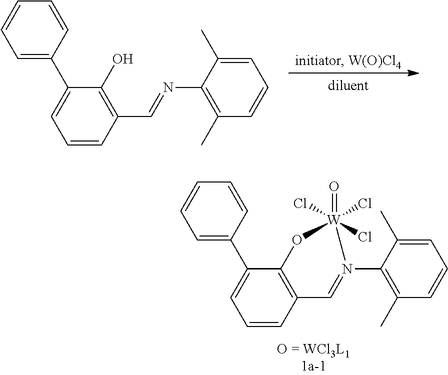

In a second nonlimiting example, the ligand may be 3-(((2-isopropylphenyl)imino)methyl)-[1,1′-biphenyl]-2-ol, referred to herein as L₂, which is L′ wherein the R₃ group in Formula L′ is an isopropyl group and the R₄ group is H). A compound of formula 1a-1 (O═WCl₃L₁) may be prepared by the reaction depicted below.

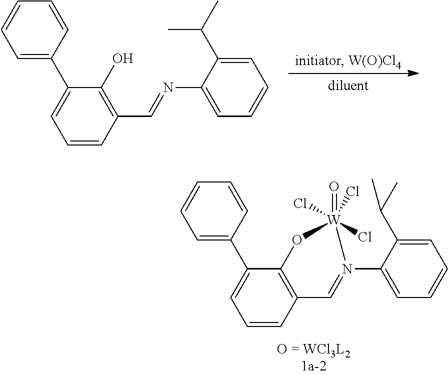

Ring-Opening Metathesis Polymerization (ROMP) Reactions

The precatalysts described herein may be used to polymerize cyclic olefin monomers to generate a polyolefin by ring-opening metathesis polymerization (ROMP). A method for performing ROMP of cyclic olefin monomers may include contacting a precatalyst of Formula (1) (e.g., Formula (1a) or more specifically Formula (1a-1) and/or Formula (1a-2)) with an activator in the presence of cyclic olefin monomers under conditions effective to generate a polyolefin.

Cyclic olefins suitable for use in the methods and compositions of the present disclosure may be strained or unstrained; monocyclic, or polycyclic; and optionally include hetero atoms and/or one or more functional groups.

Examples of cyclic olefins suitable for use as comonomers in the methods of the present disclosure include, but are not limited to, cyclooctene, 1,5-cyclooctadiene, 1-hydroxy-4-cyclooctene, 1-acetoxy-4-cyclooctene, 5-methylcyclopentene, dicyclopentadiene (DCPD), cyclopentene (cC5), norbornene, norbornadiene, cycloheptene, cyclooctene, cyclooctadiene, cyclododecene, 7-oxanorbornene, 7-oxanorbornadiene, cis-5-norbornene-endo-2,3-dicarboxylic anhydride, dimethyl norbornene carboxylate, norbornene-exo-2,3-carboxylic anhydride, and their respective homologs and derivatives, and substituted derivatives therefrom. Illustrative examples of suitable substituents include, but are not limited to, hydroxyl, thiol, ketone, aldehyde, ester, ether, amine, imine, amide, nitro, carboxylic acid, disulfide, carbonate, isocyanate, carbodiimide, carboalkoxy, and halogen.

Examples of activators suitable in the methods described above include aluminum or magnesium-containing reagents such as, but not limited to, diethylaluminum chloride, triisobutylaluminum, (trimethylsilyl)methylmagnesium chloride, and (CH₃)₂PhCH₂MgCl, ethylaluminum dichloride, methyl aluminum dichloride, dimethyl aluminum chloride, Al(OR)ₙCl₍₃₋ₙ), and the like, and any combination thereof.

ROMP may be carried out at a temperature of about −50° C. to about 50° C., or about −50° C. to about −25° C., or about −25° C. to about 25° C., or about 0° C. to about 25° C., or about 25° C. and about 50° C. Preferably, the temperature is about 0° C. to about 25° C.

ROMP may be performed in a diluent. The diluent may be different or the same as the cyclic olefin monomer undergoing polymerization. Examples of suitable diluents, other than the cyclic olefin monomer, if used, include, but are not limited to, isobutane, butane, pentane, isopentane, hexanes, isohexane, heptane, octane, dodecane, cyclohexane, cycloheptane, methylcyclohexane, methylcycloheptane, benzene, toluene, mesitylene, xylene, synthetic isoparaffins (e.g., ISOPAR™, available from ExxonMobil Chemical Company), perfluorinated C₄-C₁₀ alkanes, chlorobenzene, and the like, and any combination thereof.

The polymerization reaction may be quenched as desired by methods known in the art, for example, by adding a quenching agent. Examples of suitable quenching agents include, but are not limited to alcohols (e.g., methanol and ethanol), aldehydes, acids (e.g., hydrochloric acid), butylated hydroxytoluene, and the like, and any combination thereof.

Polymer products generated using the precatalysts described herein include polyolefins. The polyolefin may be a homopolymer or copolymer comprising mer units corresponding to the cyclic olefin monomers present in the reaction mixture during synthesis. For example, the precatalysts described herein may be suitable for polycyclopentene rubber (CPR) from cyclopentene.

For example, a precatalyst may be contacted with an activator in the presence of cyclopentene to generate polycyclopentene rubber (CBR).

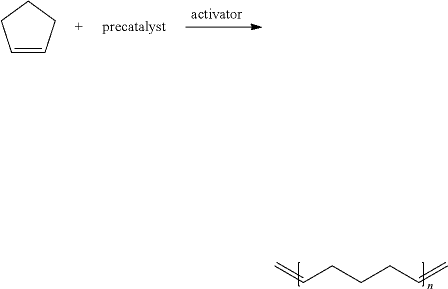

In another nonlimiting example, a precatalyst comprising a compound of Formula (1) may be contacted with an activator in the presence of cyclopentene to generate CBR as illustrated below.

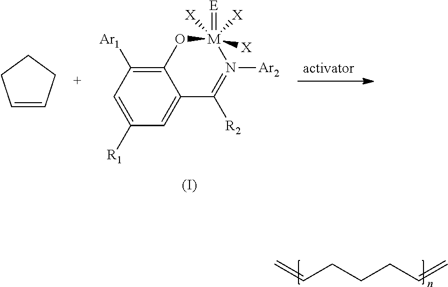

In yet more nonlimiting examples, a precatalyst comprising a compound of Formula (1a), Formula (1a-1), or Formula (1a-2) may be contacted with an activator in the presence of cyclopentene to generate CBR as illustrated in the three reaction below.

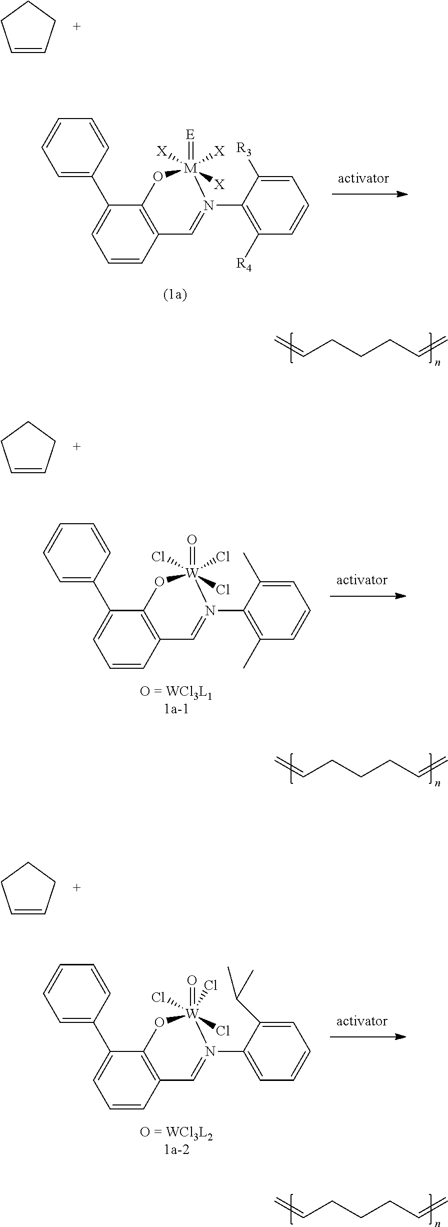

### Example Embodiments

A first nonlimiting example embodiment is a compound represented by Formula (1) where M is tungsten or molybdenum, R₁ and R₂ are independently H or C₁-C₂₀ hydrocarbyl, each X is independently a halide or′ with the proviso that at least two of the X moieties are halides, R′ is H or C₁-C₂₀ hydrocarbyl, E is oxygen (O), sulfur (S), selenium (Se), tellurium (Te), or an amide with the formula —NR, where R is H or C₁-C₂₀ hydrocarbyl; and Ar₁ and Ar₂ are independently substituted or unsubstituted C₆-C₄₀ aryl groups that optionally include one or more heteroatoms.

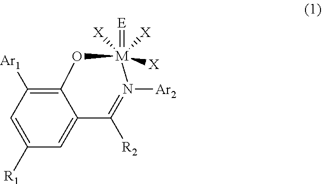

The second nonlimiting example embodiment is a compound represented by Formula (1a) where each of R₃ and R₄ are independently H or a C₁-C₂₀ hydrocarbyl

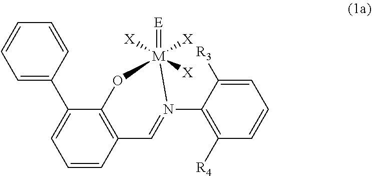

A third nonlimiting example embodiment is method of synthesizing a compound of Formula (1) comprising contacting a compound represented by Formula (L) with a compound represented by the formula M(O)X₄ in a diluent in the presence of a base, where M is tungsten or molybdenum, R₁ and R₂ are independently H or C₁-C₂₀ hydrocarbyl, each X is independently a halide or′ with the proviso that at least three of the X moieties are halides, R′ is H or C₁-C₂₀ hydrocarbyl, E is oxygen (O), sulfur (S), selenium (Se), tellurium (Te), or an amide with the formula —NR″, where R″ is H or C₁-C₂₀ hydrocarbyl; and Ar₁ and Ar₂ are independently substituted or unsubstituted C₆-C₄₀ aryl groups that optionally include one or more heteroatoms.

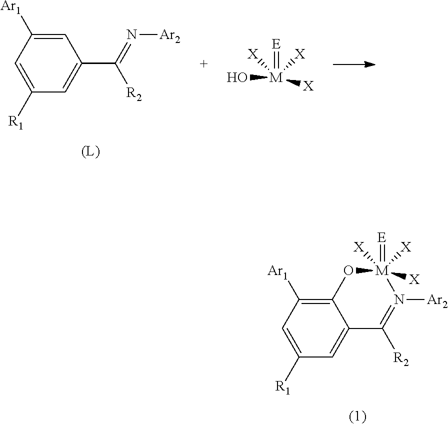

The third nonlimiting example embodiment may further include: Element 1: wherein the contacting is carried out at a temperature of between about −196° C. and about 70° C.; Element 2: wherein the contacting is carried out at a temperature of between about −196° C. and about 25° C.; Element 3: wherein Formula (L) is Formula (L′) and Formula (1) is Formula (1a) where R₃ and R₄ are independently a C₁-C₂₀ hydrocarbyl; Element 4: Element 3 and wherein Formula (L′) is 3-(((2,6-dimethylphenyl)imino)methyl)-[1,1′-biphenyl]2-ol and each X is Cl; and Element 5: Element 3 and wherein Formula (L′) is 3-(((2-isopropylphenyl)imino)methyl)-[1,1′-biphenyl]-2-ol and each X is Cl. Examples of combinations include, but are not limited to, Element 1 or Element 2 in combination with Element 3 and optionally in further combination with Element 3 or Element 4.

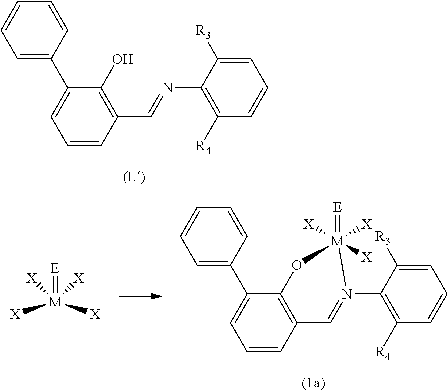

A fourth nonlimiting example embodiment is a method of polymerizing an cyclic olefin monomer comprising contacting a precatalyst of Formula (1) with an activator in the presence of the cyclic olefin monomer, wherein M is tungsten or molybdenum, R₁ and R₂ are independently H or C₁-C₂₀ hydrocarbyl, each X is independently a halide or′ with the proviso that at least three of the X moieties are halides, E is oxygen (O), sulfur (S), selenium (Se), tellurium (Te), or an amide with the formula —NR″, where R″ is H or C₁-C₂₀ hydrocarbyl; and Ar₁ and Ar₂ are independently substituted or unsubstituted C₆-C₄₀ aryl groups that optionally include one or more heteroatoms.

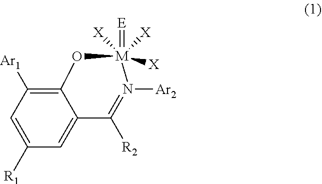

The fourth nonlimiting example embodiment may further include: Element 6: wherein the contacting is carried out at a temperature of about −50° C. and about 50° C.; Element 7: wherein the contacting is carried out at a temperature of about 0° C. and about 25° C.; Element 8: wherein the precatalyst is a compound of Formula (1a), where R₃ and R₄ are independently a C₁-C₂₀ hydrocarbyl; Element 9: Element 8 and wherein R₃ is methyl and R₄ is methyl; Element 10: Element 8 and wherein R₃ is isopropyl and R₄ is hydrogen; Element 11: wherein the cyclic olefin monomer is cyclopentene. Examples of combinations include, but are not limited to, Element 6 or Element 7 in combination with Element 8 and optionally in further combination with Element 9 or Element 10; Element 11 in combination with Element 6 or Element 7; Element 11 in combination with Element 8 and optionally in further combination with Element 9 or Element 10; Element 11 in combination with Element 6 or Element 7 and in combination with Element 8 and optionally in further combination with Element 9 or Element 10.

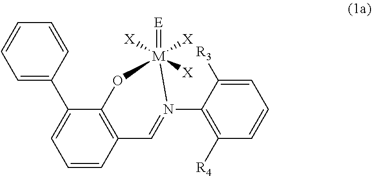

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23° C.

As used in the present disclosure and claims, the singular forms “a,” “an,” and “the” include plural forms unless the context clearly dictates otherwise.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

### Example 1

### Synthesis of L₁ (3-(((2,6-dimethylphenyl)imino)methyl)-[1,1′-biphenyl]-2-ol)

2-Hydroxybiphenyl-3-carbaldehyde (1.0 g, 5.04 mmol) and 2,6-dimethylaniline (0.64 mL, 5.04 mmol) were dissolved in 50 mL of ethanol and stirred at ambient temperature overnight. Solvent was removed under reduced pressure and the resulting oil was purified by passing it through a silica gel plug (10% acetone in isohexane) to yield an orange oil. Yield=98%.

¹H NMR (500 MHz, C₆D₆, δ): 1.95 (s, 6H), 6.76 (m, 1H), 6.85 (m, 1H), 6.90 (m, 3H), 7.16 (m, 1H), 7.29 (m, 2H), 7.36 (m, 1H), 7.77 (s, 1H), 7.79 (m, 2H), 13.84 (s, 1H).

### Example 2

### Synthesis of L₂ (3-(((2-isopropylphenyl)imino)methyl)-[1,1′-biphenyl]-2-ol)

2-Hydroxybiphenyl-3-carbaldehyde (1.0 g, 5.04 mmol) and 2-isopropylaniline (0.71 mL, 5.04 mmol) were dissolved in 50 mL of ethanol and stirred at ambient temperature overnight. Solvent was removed under reduced pressure to yield an orange oil.

¹H NMR (500 MHz, C₆D₆, δ): 1.11 (d, J=7.0 Hz, 6H), 3.47 (m, 1H), 6.66 (m, 1H), 6.78 (m, 1H), 6.95 (m, 1H), 7.02 (m, 2H), 7.08 (m, 2H), 7.26 (m, 2H), 7.37 (1H), 7.78 (m, 2H), 8.07 (s, 1H), 14.10 (s, 1H).

### Example 3

### Synthesis of Precatalyst Compound of Formula 1a-1 (O═WCl₃L₁)

In a 20 mL vial, L₁ (3-(((2,6-dimethylphenyl)imino)methyl)-[1,1′-biphenyl]-2-ol) was dissolved in toluene (5 mL) and cooled to −50° C. A solution of n-Butyllithium (0.446 mL, 2.5 M in hexanes) was added to the contents of the 20 mL vial using an automatic pipette. The resulting solution was left at room temperature for 30 minutes. After 30 minutes, the solution was cooled to −50° C. and solid tungsten(VI) oxytetrachloride (W(O)Cl₃) was added in a single portion to generate a red solution, which was stirred at room temperature for 16 hours. After 16 hours, the solvent was removed in vacuo, the solids were extracted into 10 mL dichloromethane, and the resulting mixture was filtered through diatomaceous earth (CELITE®, Sigma-Aldrich). The solvent of the filtrate was then evaporated in vacuo. The remaining solids were washed with pentane (0.5 mL). Subsequent removal of the solvent resulted in a bright red crystalline solid, which was then washed with pentane (2 mL) and dried in vacuo. The solid-state structure was confirmed by X-ray crystallographic studies.

### Example 3

### Synthesis of Precatalyst Compound of Formula 1a-2 (O═WCl₃L₂)

In a 20 mL vial, L₂ (3-(((2-isopropylphenyl)imino)methyl)-[1,1′-biphenyl]-2-ol) was dissolved in toluene (5 mL) and cooled to −50° C. A solution of n-Butyllithium (0.446 mL, 2.5 M in hexanes) was added to the contents of the 20 mL vial using an automatic pipette. The resulting solution was left at room temperature for 30 minutes. After 30 minutes, the solution was cooled to −50° C. and solid tungsten(VI) oxytetrachloride (W(O)Cl₃) was added in a single portion to generate a red solution, which was stirred at room temperature for 16 hours. After 16 hours, the solvent was removed in vacuo, the solids were extracted into 10 mL dichloromethane, and the resulting mixture was filtered through diatomaceous earth (CELITE®, Sigma-Aldrich). The solvent of the filtrate was then evaporated in vacuo. The remaining solids were washed with pentane (0.5 mL). Subsequent removal of the solvent resulted in a bright red crystalline solid, which was then washed with pentane (2 mL) and dried in vacuo.

### Example 4

### ROMP of Cyclopentene

Cyclopentene was purified by passing it through activated alumina Precatalyst (either Formula 1a-1 (O═WCl₃L₁) or Formula 1a-2 (O═WCl₃L₂)) was dissolved in toluene (3 mL) after which purified cyclopentene (1.0 g) was added. The mixture was stirred at room temperature. After visual confirmation of viscosity change, the polymerization reaction was quenched with ethanol (10 mL) and the polymer product was dried under argon. Table 1 below reports the reaction conditions of each reaction.

TABLE 1

| | Catalyst | | Amount | | Reaction |
|---|---|---|---|---|---|
| | Molecular | | of | | Temper- |
| Pre- | Weight | Amount of | Catalyst | | ature |
| catalyst | (g/mol) | Catalyst (g) | (mol) | Activator | (° C.) |
| 1a-1 | 592.54 | 1.00 × 10⁻² | 1.69 × 10⁻⁵ | Me₃SiCH₂MgCl | 25 |
| 1a-2 | 620.6 | 1.00 × 10⁻² | 1.61 × 10⁻⁵ | Me₃SiCH₂MgCl | 25 |

Table 2 below reports the properties of the polymer product generated using each of the precatalysts.

TABLE 2

| Precatalyst | M_{w} (g/mol) | Mₙ (g/mol) | M_{w}/Mₙ | cis/trans |
|---|---|---|---|---|
| 1a-1 | 397,302 | 155,511 | 2.6 | 75/25 |
| 1a-2 | 213,780 | 78,539 | 2.7 | 67/33 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A compound represented by Formula (1) 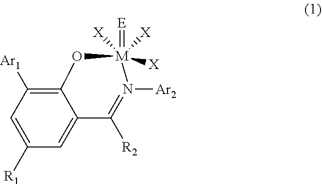
where M is tungsten or molybdenum, R₁ and R₂ are independently H or C₁-C₂₀ hydrocarbyl, each X is independently a halide or OR′ with the proviso that at least two of the X moieties are halides, R′ is H or C₁-C₂₀ hydrocarbyl, E is oxygen (O), sulfur (S), selenium (Se), tellurium (Te), or an amide with the formula —NR, where R is H or C₁-C₂₀ hydrocarbyl; and Ar₁ and Ar₂ are independently substituted or unsubstituted C₆-C₄₀ aryl groups that optionally include one or more heteroatoms.

2. The compound of claim 1, depicted by Formula (1a) 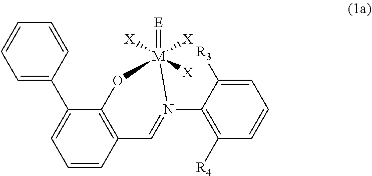
where each of R₃ and R₄ are independently H or a C₁-C₂₀ hydrocarbyl.

3. A method of synthesizing a compound of Formula (1) comprising contacting a compound represented by Formula (L) with a compound represented by the formula M(O)X₄ in a diluent in the presence of an base, 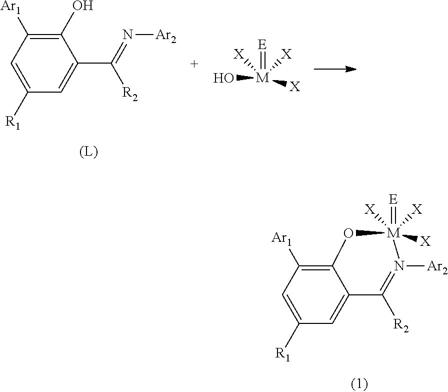
where M is tungsten or molybdenum, R₁ and R₂ are independently H or C₁-C₂₀ hydrocarbyl, each X is independently a halide or OR′ with the proviso that at least three of the X moieties are halides, R′ is H or C₁-C₂₀ hydrocarbyl, E is oxygen (O), sulfur (S), selenium (Se), tellurium (Te), or an amide with the formula —NR″, where R″ is H or C₁-C₂₀ hydrocarbyl; and Ar₁ and Ar₂ are independently substituted or unsubstituted C₆-C₄₀ aryl groups that optionally include one or more heteroatoms.

4. The method of claim 3, wherein the contacting is carried out at a temperature of between about −196° C. and about 70° C.

5. The method of claim 3, wherein the contacting is carried out at a temperature of between about −196° C. and about 25° C.

6. The method of claim 3, wherein the diluent is pentane, hexane, heptane, cyclohexane, benzene, toluene, xylene, ethyl benzene, and any combination thereof.

7. The method of claim 3, wherein Formula (L) is Formula (L′) and R₃ and R₄ are independently a C₁-C₂₀ hydrocarbyl

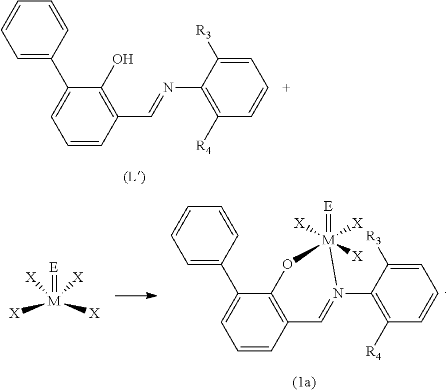

8. The method of claim 7, wherein Formula (L′) is 3-(((2,6-dimethylphenyl)imino)methyl)-[1,1′-biphenyl]-2-ol and each X is Cl.

9. The method of claim 7, wherein Formula (L′) is 3-(((2-isopropylphenyl)imino)methyl)-[1,1′-biphenyl]-2-ol and each X is Cl.

10. A method of polymerizing an cyclic olefin monomer comprising contacting a precatalyst of Formula (1) with an activator in the presence of the cyclic olefin monomer 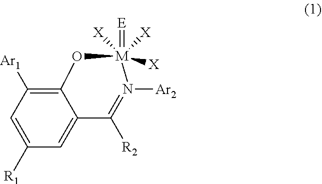
wherein M is tungsten or molybdenum, R₁ and R₂ are independently H or C₁-C₂₀ hydrocarbyl, each X is independently a halide or OR′ with the proviso that at least three of the X moieties are halides, E is oxygen (O), sulfur (S), selenium (Se), tellurium (Te), or an amide with the formula —NR″, where R″ is H or C₁-C₂₀ hydrocarbyl; and Ar₁ and Ar₂ are independently substituted or unsubstituted C₆-C₄₀ aryl groups that optionally include one or more heteroatoms.

11. The method of claim 10, wherein the contacting is carried out at a temperature of about −50° C. and about 50° C.

12. The method of claim 10, wherein the contacting is carried out at a temperature of about 0° C. and about 25° C.

13. The method of claim 10, wherein the precatalyst is a compound of Formula (1a), 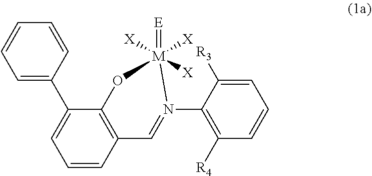
where R₃ and R₄ are independently a C₁-C₂₀ hydrocarbyl.

14. The method of claim 13, wherein R₃ is methyl and R₄ is methyl.

15. The method of claim 13, wherein R₃ is isopropyl and R₄ is hydrogen.

16. The method of claim 10, wherein the cyclic olefin monomer is cyclopentene.
